(19) United States
(12) Patent Application Publication
(10) Pub. No.: US 2006/0291118 A1
(43) Pub. Date: Dec. 28, 2006

(54) Power transmission line equipped with a protection circuit

(75) Inventor: Michael Chen, Taipei Hsien (TW)

Correspondence Address: BIRCH STEWART KOLASCH & BIRCH, PO BOX 747, FALLS CHURCH, VA, 22040-0747, US

(73) Assignee: TOPOWER COMPUTER INDUSTRIAL CO., LTD.

(21) Appl. No.: 11/167,199

(22) Filed: Jun. 28, 2005

(51) Int. Cl. H02H 3/00

(52) U.S. Cl. 361/91.1

(57) ABSTRACT

A power transmission line equipped with a protection circuit includes a power transmission line bridging a power supply to provide DC and a load driven by the DC. The power transmission line has a power line equipped with a protection circuit. The protection circuit can open the power line or interrupt a closed circuit or temporarily suspend power supply to the load when an over-current or over-voltage condition occurred to the DC so that the load is protected from being overloaded and damaged.

### FIELD OF THE INVENTION

The present invention relates to a power transmission line equipped with a protection circuit and particularly to a power transmission line for transmitting DC between a power supply and a load that has a protection circuit to provide over-current and over-voltage overload protection.

### BACKGROUND OF THE INVENTION

With thriving of multimedia technology and the Internet applications, the performance of hardware (such as hard disks, card readers, optical disk burners, high end graphic cards and the like) for personal computers or servers also increases significantly. This is especially true for the graphic cards that aim to process video image to meet multimedia video/audio requirements. Some graphic cards are so powerful now that they are equipped with independent power supply and cooling capability.

Whatever the hardware type, the power supply always has to provide a steady DC power. This is because AC is often unstable or abnormal conditions such as thunderstroke could happen. While the power supply usually has an over-current or over-voltage protection circuit in response to the aforesaid situations and to provide a steady electricity quality. But from the perspective of consumer market, hardware burn-out due to improper electricity caused by the power supply still occurs. This is because the power transmission line could transmit abnormal electric signal to the hardware at the rear end even though the power supply already has the protection circuit installed when a surged energy is greater than the protection circuit mechanism. There are other situations happened to the hardware equipment in a use condition, such as the load of the hardware equipment abruptly drops from a heavy condition to a light condition, the DC voltage input to the hardware equipment increases, or the connector of the power transmission line has a higher impedance due to repeatedly plugging and unplugging. All these conditions will cause the DC input to the hardware equipment to generate an over-current or over-voltage condition, and the hardware equipment could be damaged. From user's standpoint, buying new hardware equipment is costly. Moreover, as the information technology advances and updates constantly, to find out the hardware equipment of the same specifications for replacement is increasingly difficult.

### SUMMARY OF THE INVENTION

Therefore the primary object of the present invention is to solve the aforesaid disadvantages. The invention aims to provide a protection circuit on a power transmission line that provides over-current or over-voltage protection function during DC transmission of the power transmission line whether the power supply has protection function for over-current or over-voltage, and the protection circuit can be opened or the closed circuit interrupted or electric supply to a load is temporarily suspended when over-current or over-voltage condition happened to the power transmission during DC transmission so that the load (hardware equipment) at the rear end driven by the DC can be protected during abnormal conditions of the DC supply, and damage caused by overloading can be avoided.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of the present invention.

FIG. 2 is a circuit block diagram of a first embodiment of the invention.

FIG. 3 is a circuit block diagram of a second embodiment of the invention.

FIG. 4 is a circuit block diagram of a third embodiment of the invention.

FIG. 5 is a circuit block diagram of a fourth embodiment of the invention.

FIG. 6 is a circuit block diagram of a fifth embodiment of the invention.

FIG. 7 is a circuit block diagram of a sixth embodiment of the invention.

### DETAILED DESCRIPTION OF THE PREFERRED EMBODIMENTS

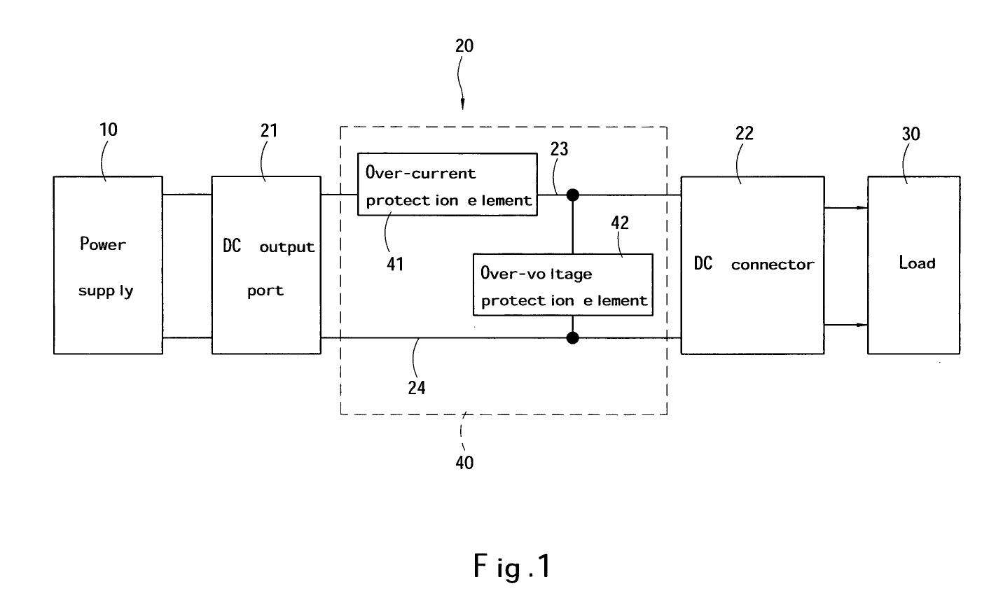

Please refer to FIG. 1 for a circuit block diagram of the present invention. The invention includes a power supply 10 to provide DC and a load 30 driven by the DC, and a power transmission line 20 bridging the power supply and the load to transmit the DC. In the following embodiments, the power supply 10 has a DC output port 21, and the power transmission line 20 has twin electric conductive lines 23 and 24 and a DC connector 22. All the drawings serve only for illustrative purpose, and are not the limitation of the invention. This invention can also be adapted to other configurations that include the power supply 10 and the power transmission line 20 for DC transmission. The invention mainly includes a protection circuit 40 on a power line of the power transmission line 20. The protection circuit 40 can open the power line, or interrupt the closed circuit, or temporarily suspend electric supply to the load 30 when an over-current or over-voltage condition occurs to the DC supply so that the load 30 may be protected from overloading or being damaged.

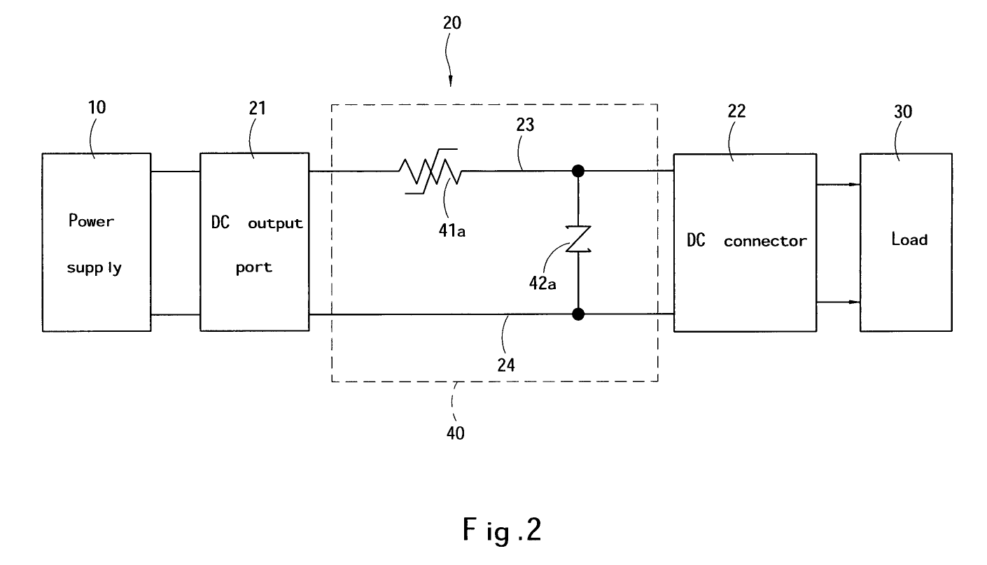

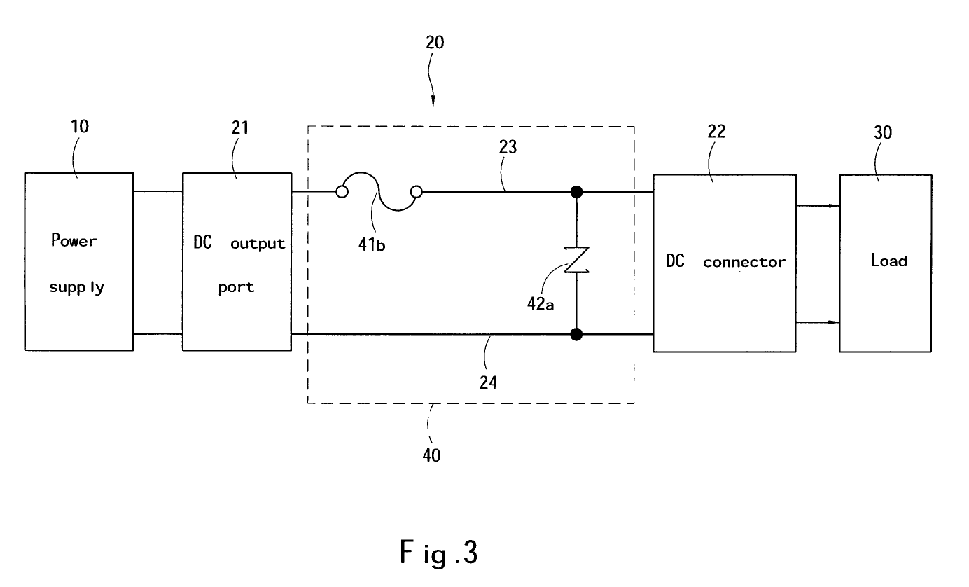

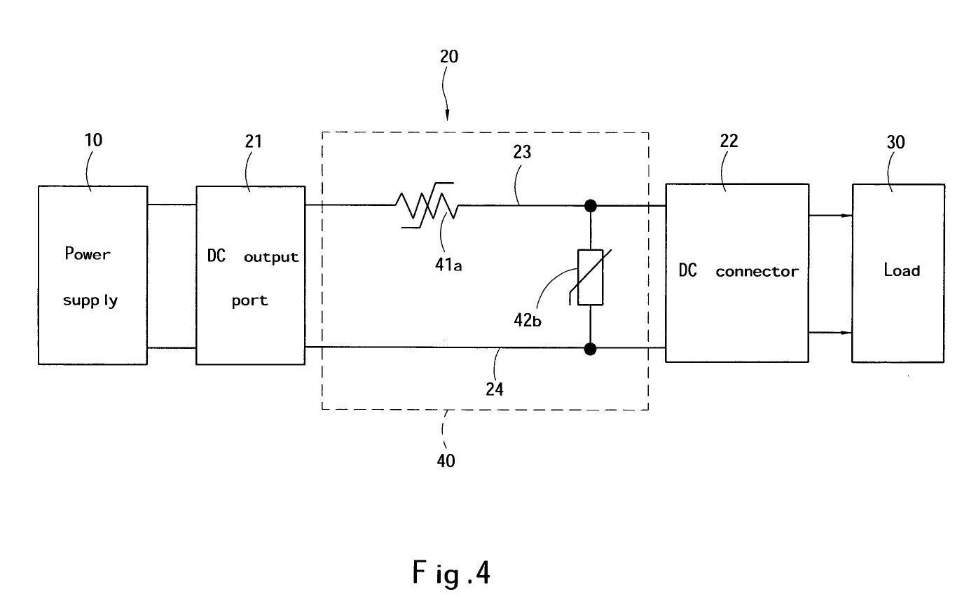

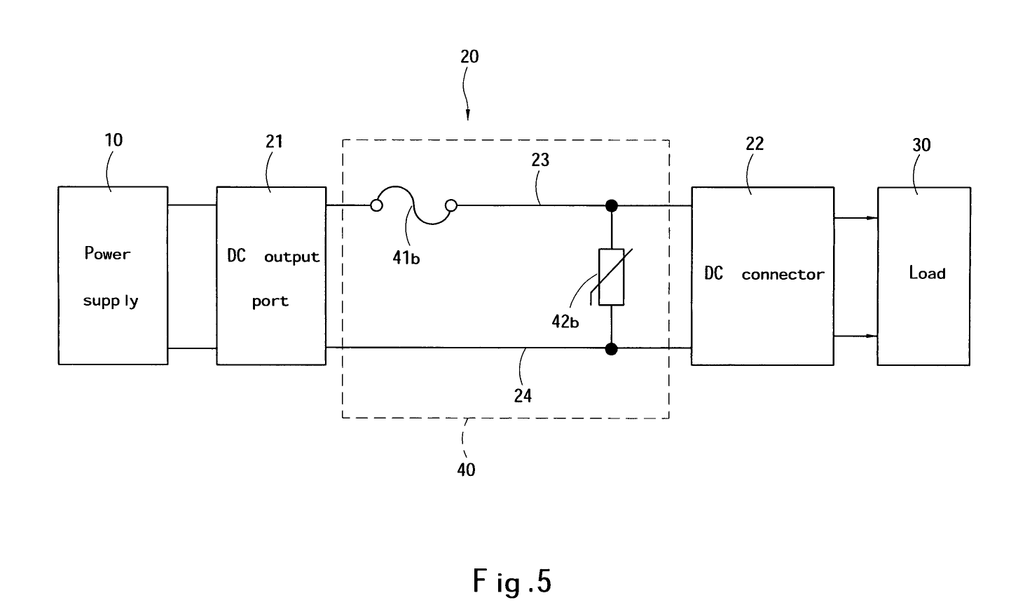

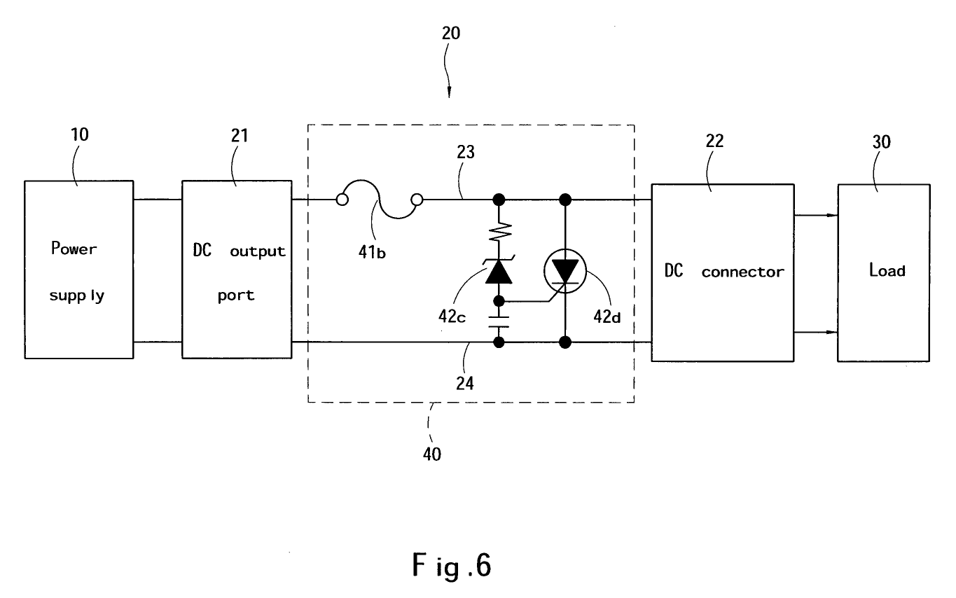

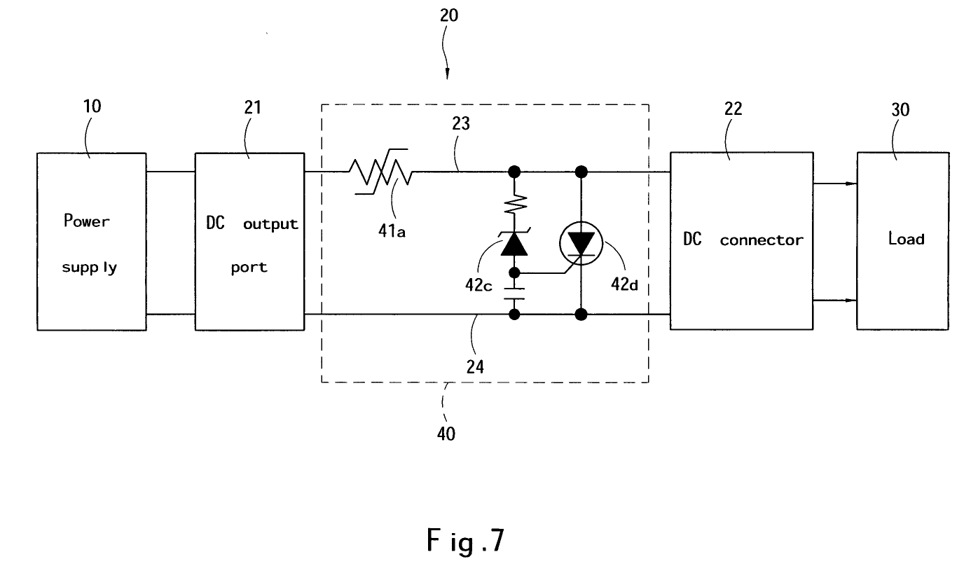

Refer to FIGS. 2 to 7 for various embodiments of the protection circuit 40 of the invention to protect the over-current and over-voltage conditions. The protection circuit 40 includes at least one over-current protection element 41 coupled in series to a pair of electric conductive lines 23 and 24 of the power line. The over-current protection element 41 is a fuse 41a or a PolySwitch 41b. The two electric conductive lines 23 and 24 are coupled in series with a over-voltage protection element 42 which may be a combination of a ZNR 42a, a Varistor 42b or a Zener 42c with a silicon control rectifier (SCR) 42d. The electronic elements set forth above may be altered and coupled in varying configurations according to their electric characteristics. The common electric conditions are as discussed as follow:

When an abnormal condition or other factors occur to the power supply 10, and the DC output from the DC output port 21 exceeds the limit of the over-current protection element 41, the over-current protection element 41 opens the electric conductive lines 23 and 24 that are electrically connected thereof so that the DC that originally drives the load 30 via the DC connector 22 is interrupted. In the event that an over-voltage condition occurs, such as an instantaneous energy is too large due to thunderstroke, or the voltage difference is too large because of the abrupt change from a heavy load to a light load, the over-voltage protection element 42 forms a closed circuit between the two electric conductive lines 23 and 24 to temporarily suspend DC transmission to the load 30. Therefore, by means of the invention, the load 30 can be protected without burning or damage from overloading because of the over-current and over-voltage protection function provided by the protection circuit 40 on the power transmission line 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power transmission line equipped with a protection circuit comprising a power transmission line between a power supply to provide DC and a load driven by the DC, wherein:
the power transmission line has a protection circuit on a power line, the protection circuit opening the power line or interrupting a closed circuit or temporarily suspending electric supply to the load when a DC over-current or over-voltage condition occurs to prevent the load from being overloaded and damaged.

2. The power transmission line equipped with a protection circuit of claim 1, wherein the protection circuit has at least one over-current protection element coupled in series with the power line.

3. The power transmission line equipped with a protection circuit of claim 2, wherein the over-current protection element is a fuse.

4. The power transmission line equipped with a protection circuit of claim 1, wherein the over-current protection element is a PolySwitch.

5. The power transmission line equipped with a protection circuit of claim 1, wherein the protection circuit has an over-voltage protection element coupled with two electric conductive lines of the power line in series.

6. The power transmission line equipped with a protection circuit of claim 5, wherein the over-voltage protection element is a Varistor.

7. The power transmission line equipped with a protection circuit of claim 5, wherein the over-voltage protection element is a ZNR.

8. The power transmission line equipped with a protection circuit of claim 5, wherein the over-voltage protection element includes a Zener and a SCR.
